(19) United States
(12) Patent Application Publication
(10) Pub. No.: US 2018/0235827 A1
(43) Pub. Date: Aug. 23, 2018

(54) FOOT ORTHOTIC

(71) Applicants: Jeffrey S. RICH, Queens, NY (US); Ron NOY, New York, NY (US)

(72) Inventors: Jeffrey S. RICH, Queens, NY (US); Ron NOY, New York, NY (US)

(21) Appl. No.: 15/797,673

(22) Filed: Oct. 30, 2017

Related U.S. Application Data
(60) Provisional application No. 62/461,512, filed on Feb. 21, 2017.

(51) Int. Cl. A61H 1/00

(52) U.S. Cl. CPC A61H 1/008; A43B 17/006

(57) ABSTRACT

A foot orthotic with an orthotic surface pressing against a bottom of a foot of the patient. The orthotic has a treatment area and a non-treatment area. The treatment area is arranged and formed to apply a treatment pressure under a set of tendons, that preferably includes an abductor hallucis of the foot. The treatment area applies the treatment pressure when the patient walks with the orthotic surface pressing against the foot. The treatment pressure is applied across 10-100% of a full lateral width of the abductor hallucis, and is applied along front to back length of the foot in a range of 10% to 75% of a total length of the abductor hallucis. The non-treatment area is arranged around the treatment area. The treatment pressure is higher than a non-treatment pressure that the non-treatment area applies to the foot.

### CROSS REFERENCE TO RELATED APPLICATIONS

This application claims the benefit of priority of U.S. provisional application 62/461,512 filed Feb. 21, 2017, the entire contents of which are incorporated herein by reference.

### FIELD OF THE INVENTION

The present invention relates to the field of orthotics, and in particular for an orthotic/orthosis to treat plantar fasciitis, heel spurs and other foot pain.

### BACKGROUND OF THE INVENTION

There are many causes of heel and arch pain. Tight arches, over pronation, weak toe flexor tendons and tight calves all lead to inflammation of the connective tissue that forms the arch of the foot, the plantar fascia. This condition is called plantar fasciitis and/or heel spurs, and it can be very painful, from your first step in the morning to standing and walking.

Plantar fasciitis and heel spur syndrome has affected ordinary people, recreational athletes as well as many high paid professional athletes. In some cases it has sidelined people for up to weeks or even years with heel and arch pain. This can cost patients lost time at work and professional sports teams money and production.

Plantar fasciitis is often caused by tight calf muscles. The calf muscle attaches to the top of the calcaneus (heel bone). On the other end of the calcaneus, the plantar fascia attaches to the heel bone and then runs all the way to the front of the toes. When walking, the tight calf muscle pulls the heel bone back and up. This in turns pulls on the plantar fascia, and causes the toe to flex. This combined action results in the plantar fascia to become overworked and is very painful and debilitating.

In the past NSAID-Non Steroidal Anti-Inflammatory, arch supports/orthotics, gel heels and gel insoles have been used in trying to alleviate pain. Stretches of the calf muscle complex can help relieve arch tightness. Other relief that sometimes helps with rolling the arch with a golf ball, frozen water stretching the calf muscle and even physical therapy. These treatments can be expensive, painful, time consuming, and often less than 50% effective in most cases in alleviating the pain and can take months.

In addition to tight calf muscles, recent studies have found that weakness in the flexor brevis tendon is what causes arch pain, plantar fasciitis and/or heel pain. The fascia's tendon is making up for what the brevis tendon is supposed do, but is not doing, flexing the toes. The fascia tendon makes up for this constant flexion of the toes resulting in the plantar fascia being overworked.

### SUMMARY OF THE INVENTION

It is an object of the present invention to provide an orthotic/orthosis to alleviate foot pain of a patient. This orthotic/orthosis that can be used to press against the bottom of the foot while the patient is walking, especially when the foot supports the patient.

The orthotic includes a material with an orthotic surface pressing against a bottom of a foot of the patient. The material has a treatment area and a non-treatment area. The treatment area is arranged and formed to apply a treatment pressure under a set of tendons, that preferably includes an abductor hallucis of the foot. The treatment area applies the treatment pressure when the patient walks with the orthotic surface against the foot. The treatment pressure is applied across 10-100% of a full lateral width of the abductor hallucis, and is applied along front to back length of the foot in a range of 10% to 75% of a total length of the abductor hallucis. The non-treatment area is arranged around the treatment area. The treatment pressure is higher than a non-treatment pressure that the non-treatment area applies to the foot.

With the treatment area incorporated into an orthotic, sports wrap, compression sock, ankle support, arch wrap, etc., a patient can alleviate pain in 3-7 days without painful injections like PRP or shock wave therapy. Using the treatment area described the patient walks the plantar fasciitis away. Every step the patient makes applies the treatment pressure and massages the bottom of the foot. As the patient steps the treatment area massages and relaxes the plantar fascia tendon while stimulating the tendons on the bottom of the foot.

The arrangement of the treatment area and the non-treatment area with its different pressures is preferably embodied with a wedge or block that massages the plantar fascia on every step. The difference in the pressures causes the treatment pressure to act like a trigger point enabling the flexor brevis tendon to activate and enabling the plantar fascia tendon do what it was designed to do which is to support the arch and not flex the toes.

The treatment structure which causes the treatment pressure in the treatment area can be incorporate into an orthotic, sock, brace. This treatment structure can be incorporated into a flat shim as thin as 1/16″ for a dress shoe, or ⅛th to 3/16″ for a sport shoe like a sneaker or a block just placed into a shoe. The block is positioned under the arch.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a plantar view of the bones of the foot;

FIG. 2 is a plantar view of the plantar fascia tendon complex;

FIG. 3 is a plantar view of the first layer of the plantar muscles of the foot;

FIG. 4 is a dorsal view of the foot sitting on the top of an orthotic;

FIG. 5 is a perspective view of an embodiment where the treatment area extends across at least a large portion of the orthotic;

FIG. 6 is a perspective view of an embodiment where the treatment area extends across a shorter portion of the orthotic;

FIG. 7 is a cross sectional view through the orthotic according to line VII-VII in FIG. 4;

FIG. 8 is another embodiment of a cross sectional view through the orthotic according to line VII-VII in FIG. 4;

FIG. 9 is still another embodiment of a cross sectional view through the orthotic according to line VII-VII in FIG. 4;

FIG. 10 is still another embodiment of a cross sectional view through the orthotic;

FIG. 11 is still another embodiment of a cross sectional view through the orthotic; and

FIG. 12 is another embodiment of a different sized orthotic with the treatment area having a varying and massaging surface.

### DESCRIPTION OF THE PREFERRED EMBODIMENTS

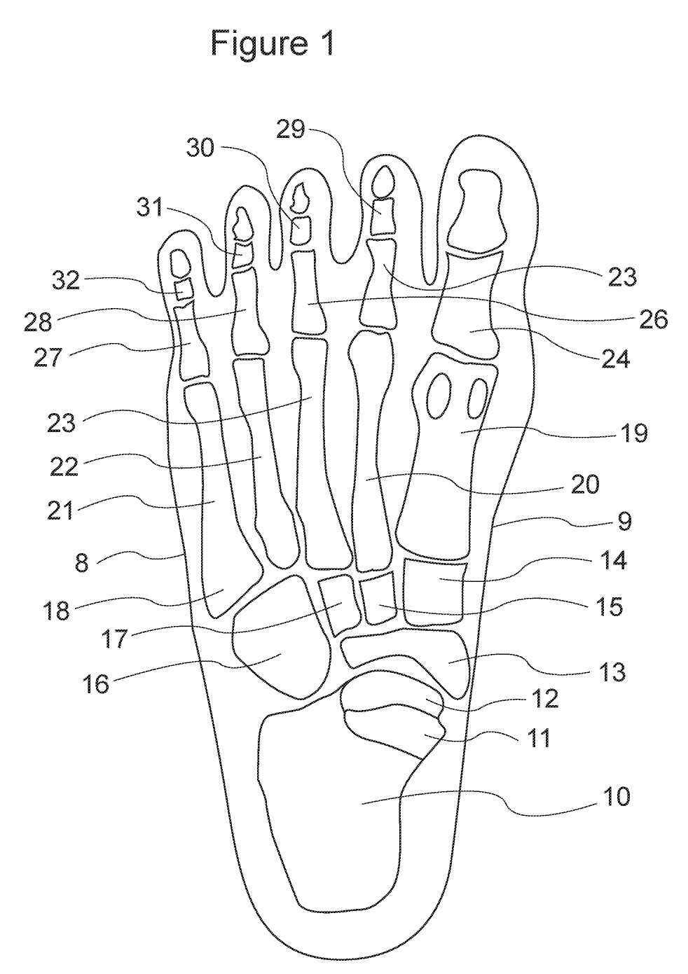

Referring to the drawings in particular, FIG. 1 shows a plantar view of the foot with the medial side 9, the lateral side 8, the calcaneus 10 the sustentaculum 11, the talus 12, the navicular 13, 1st cuneiform 14, the 2nd cuneiform 15, 3rd cuneiform 17, the cuboid 16, the styloid process 18, the first metatarsal shaft 19, second metatarsal shaft 20, third metatarsal shaft 23 fourth metatarsal shaft 22, fifth metatarsal shaft 21, 1st proximal phalanx 24, 2nd proximal phalanx 25, 3rd proximal phalanx 26, 4th proximal phalanx 27, 5th proximal phalanx 28, 2nd middle phalanx 29, 3rd middle phalanx 30, 4th middle phalanx 31, 5th middle phalanx 32.

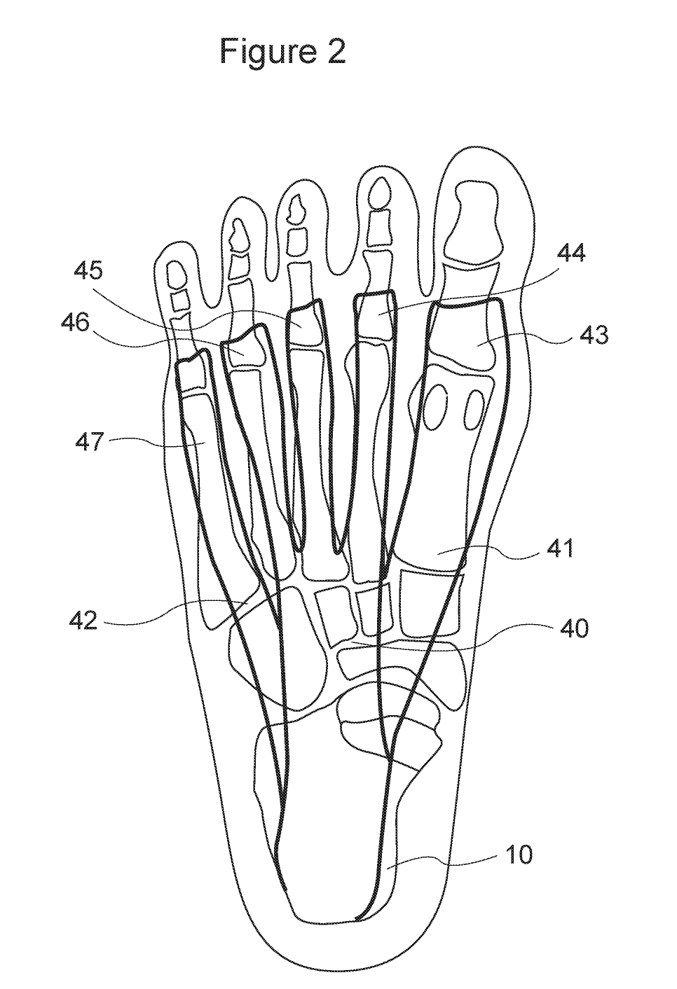

FIG. 2 shows the tendons on the bottom of the foot, the first layer sitting beneath the skin is the plantar fascia bands. One of those bands being the plantar fascia central band 40. The plantar fascia breaks into five sections one for each toe 43-47, plantar fascia medial band 41, and plantar fascia lateral band 42.

FIG. 3 shows the next layer right beneath the plantar fascia band, which is the first layer of plantar muscles of the foot. On the medial side is the flexor abductor hallucis 51. In the middle of the foot is the flexor digitorum brevis 50, and on the lateral side is the abductor digiti quinti 52. The flexor digitorum brevis 50 attaches to the middle phalanx of the toes 53-56.

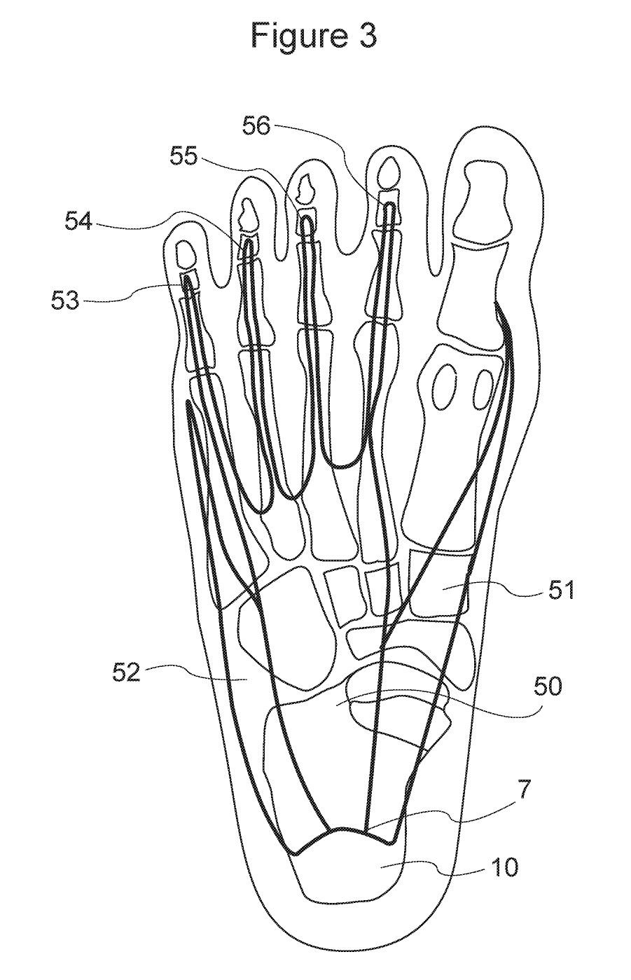

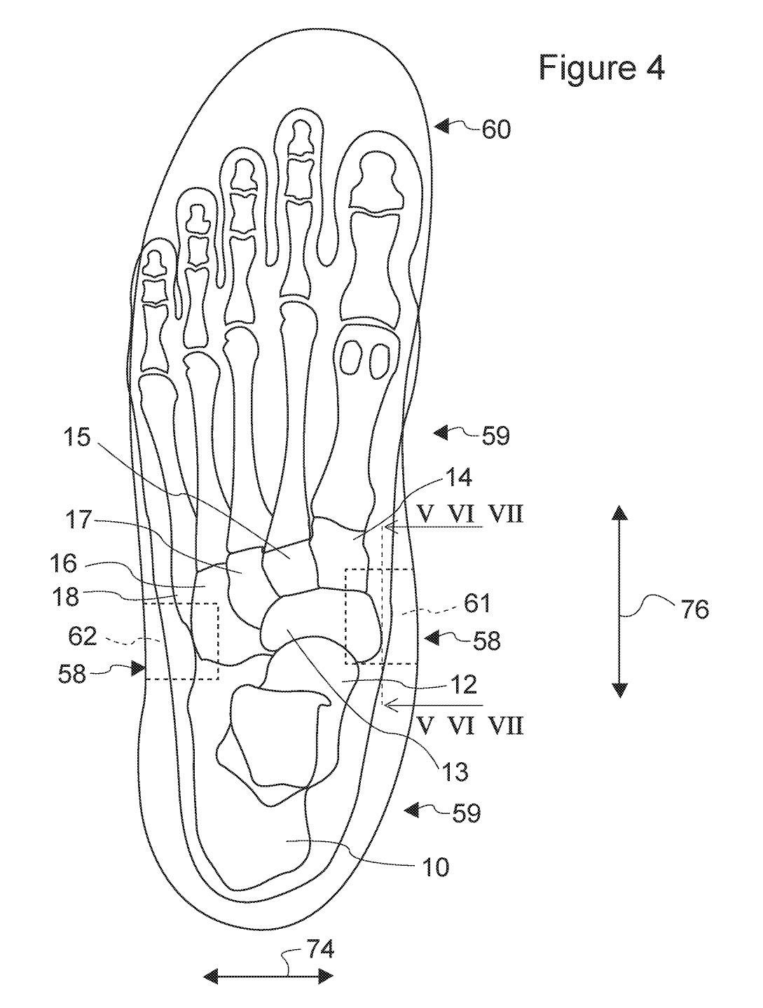

In FIGS. 4-7, an orthotic 60 is superimposed with the bones of the foot. The orthotic 60 has a treatment area(s) 58 and a non-treatment area(s) 59. One of the treatment areas 58 can be a medial plantar fascia block 61. Another treatment area 58 can be a lateral plantar fascia block 62. Many other treatment areas 58 are possible on the orthotic 60 according to the features described hereinafter.

In one embodiment of the invention as shown in FIG. 4, the treatment area 58 includes the medial plantar fascia block 61. When the treatment area/medial plantar fascia block 61 is placed on the medial side of the foot, the treatment area 61 is arranged and formed to press on the abductor hallucis 51 and the flexor digitorum brevis 52 during every step of the patient in order to massage both tendons. The treatment area 61 interacts with, or activates, the abductor hallucis 51 and the flexor digitorum 52 to act as a trigger point causing or allowing both the abductor hallucis 51 and the flexor digitorum brevis 52 to engage and contract which causes the respective toes to flex every step. This allows the plantar fascia bands 40, 41, 42 to relax while massaging the plantar fascia central band 40 and the plantar fascia medial band 41 on every step. Without the treatment area 61, the plantar fascia tendon complex 40, 41, 42, where it breaks into five sections one for each toe 43-47, flexes the toes every step creating an overuse syndrome causing arch and/or heel pain where the plantar fascia insert into the calcaneus 7 when standing, walking or doing sports. If the patient has weak abductor hallucis 51, flexor digitorum brevis 50 and abductor digiti quinti 52, then the plantar fascia complex 40, 41, 42, 43, 44, 46 has to compensate. When the treatment area 61 is placed on the medial side, the treatment area 61 acts as a trigger point activating both the abductor hallucis 50 and flexor digitorum brevis 51.

In another embodiment, the treatment area 58 includes the lateral plantar fascia block 62, which is placed on the lateral side of the foot, and is arranged and formed to create a trigger point activating the abductor digiti quinti 52.

The treatment area 58, when embodied as the medial plantar fascia block 61, can be positioned under/against the talus 12 and navicular bone 13. The medial plantar fascia block 61 can also be placed under/against the 1st cuneiform 14 or 1st metatarsal shaft 15 on the medial 9 side of the foot. The treatment area 58, when embodied as the lateral plantar fascia block 62 also can be placed on the lateral side 8 of the foot placed under/against the cuboid 16.

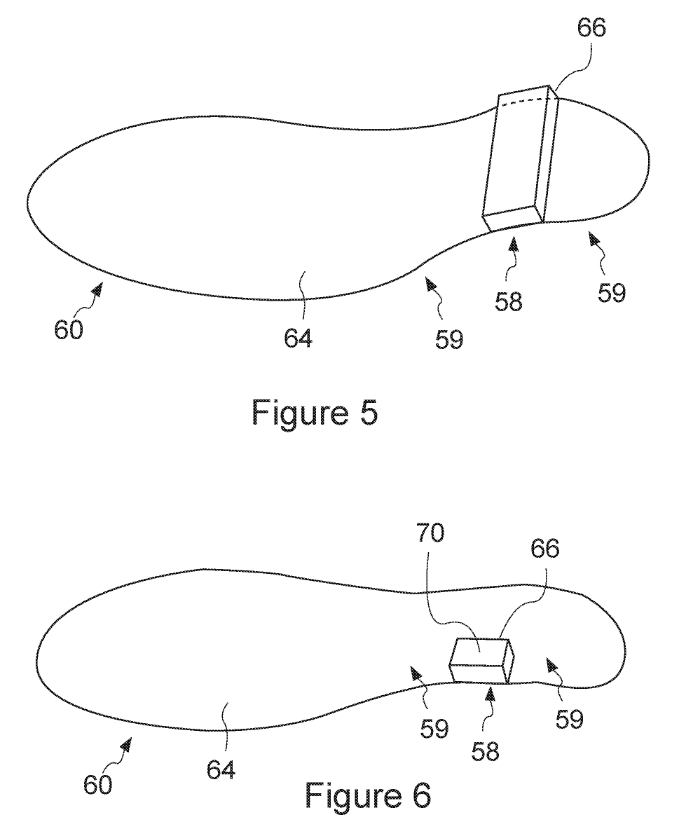

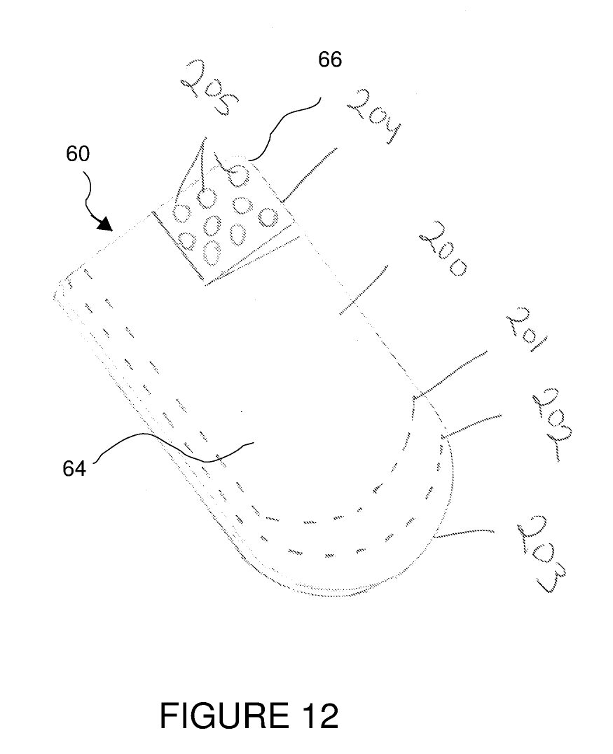

The orthotic 60 is in one preferred embodiment, a insert shaped somewhat similar to the foot of the patient and which can be placed inside a shoe, as shown in FIGS. 5 and 6. The orthotic 60 could also be a sock that is placed around the foot, or incorporated into a shoe, or other footwear. The orthotic 60, as shown in FIG. 12, can also be a flat heel to mid foot support made from leather, foam, vinyl or similar, from paper thin to ⅛ of an inch thick. A preferred thickness is 1/32 to 1/16 of an inch. In the embodiment shown in FIG. 12, the orthotic 60 is a ⅓ length heel cup 200 that is shown flat, but it can also be a cup shaped heel cup. The orthotic 60 can be any structure that applies pressure to the tendons as described herein, and/or activates those tendons as described herein.

In one embodiment of the orthotic 60, as shown in FIG. 5-7, there is a base structure 64 and treatment structure 66. The treatment structure 66 is placed on top of the base structure 64, and the treatment structure 66 is shaped, arranged and formed of a material to apply a treatment pressure to the foot of the patient. The treatment pressure applied by the treatment structure 66 is higher than a non-treatment pressure which is applied to the foot by the base structure 64 that surrounds the treatment structure 66. The treatment structure 66 applies the treatment pressure at least in part because of the height difference 68 between the top 70 of the treatment structure 66 and the top 72 of the base structure 64. The treatment structure 66 can also contribute to the treatment pressure based on the material of the treatment structure 66.

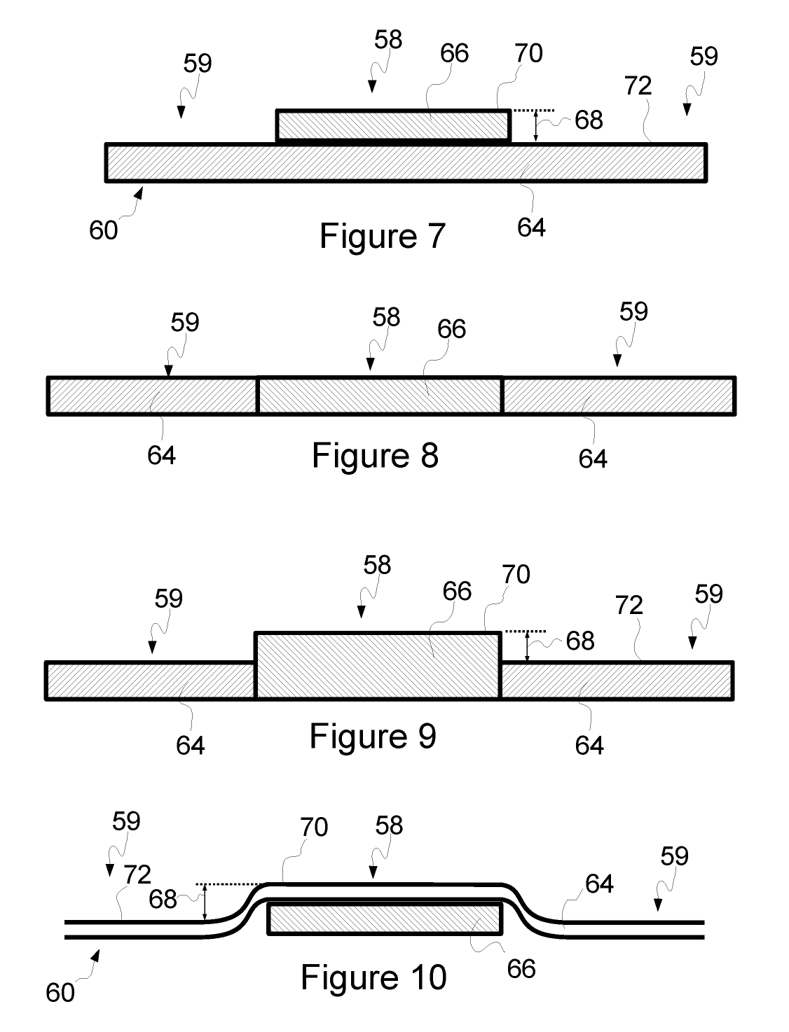

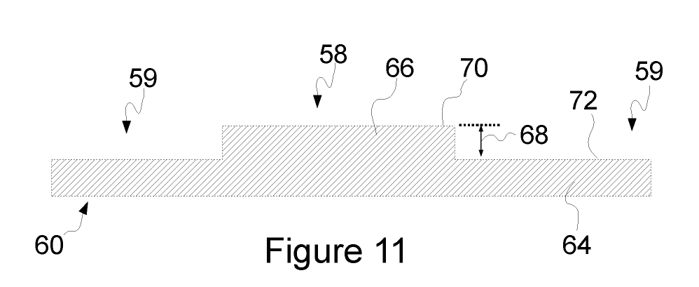

The base structure 64 and the treatment structure 66 can be made from separate discrete structures with the treatment structure 66 fastened to the base structure 64 as shown in FIG. 7. The treatment structure 66 can be fastened by chemical adhesion, such as glue, or fastened by a melting of the base structure 64 and/or treatment structure 66, as in welding, or even by a melting of a third substance as in brazing. The base structure 64 and the treatment structure 66 can also be made from a single homogeneous material as shown in FIG. 11. The single homogeneous material could be a single density foam, poron or silicone rubber in a hardness range of 15 to 25 Durometer (D) on the Shore C scale, or 30 to 50 Durometer on the Shore C scale. The difference between the non-treatment pressure and the treatment pressure with the single homogeneous material in FIG. 11 coming about primarily by the difference 68 in height of the top 70 of the treatment structure 66 and the top 72 of the past structure 64.

In the embodiment of FIG. 8, the treatment structure 66 is incorporated into the same layer as the base structure 64. The treatment structure 66 in this embodiment is also shaped, arranged and formed of a material to apply the treatment pressure to the foot of the patient. In the embodiment of FIG. 8, the treatment pressure is primarily determined by the material of treatment structure 66, and in particular that the treatment structure 66 has a higher force of compressibility than the base structure 64. Base structure 64 can have softer more compressible foam, and treatment structure 66 should be firmer. As the foot sinks into base structure 64 it makes treatment structure 66 feel higher thus applying the treatment pressure into the designated areas of the foot.

In the embodiment of FIG. 9, the treatment structure 66 is both incorporated into the layer/level of the base structure 64, and has a top surface 70 that is above a top surface 72 of the base structure by a height 68. The treatment structure 66 in FIG. 9 creates the treatment pressure by both the height difference 68, and by the difference in the materials of the treatment structure 66 and the base structure 64.

In FIG. 10, the treatment structure 66 is placed under the base structure 64, but still is able to apply treatment pressure to desired areas of the foot because of the flexibility of the base structure 64.

The treatment pressure is applied at least in part, because of how the orthotic 60 and the foot of the patient compresses when the foot presses against the orthotic 60. The greater the height difference 68, the more pressure is applied to the foot because the top surface 70 contacts the bottom of the foot first, and therefore starts compressing the foot to a greater degree than the top surface 72 of the base structure 64. A difference in the compressibility, firmness, and/or softness of the base structure 64 and the treatment structure 66 can also cause the treatment pressure to be higher than the non-treatment pressure if the material of the treatment structure 66 is less compressible, more firm, and/or less soft than the material of the base structure 64. Other features of the treatment structure 66 and the base structure 64 to have the treatment pressure be higher than the non-treatment pressure are also possible.

The treatment pressure applied by the treatment area 58 through the treatment structure 66 to the foot is preferably 50-100 kPa higher than the non-treatment pressure which is applied to the foot by the base structure 64 in the non-treatment area 59. The magnitude of the treatment pressure should be large enough to activate/trigger the respective tendons to alleviate plantar fasciitis. The magnitude of the treatment pressure should also be low enough to not cause excessive discomfort to the patient when the patient stands and/or walks on the treatment area 58. A treatment pressure in a range of 125-250 kPa is desirable, with a range of 150-250 kPa being more desirable, and particular preferably a treatment pressure of approximately 200 kPa being optimal for many patients.

Suitable materials for the treatment structure 66 have a hardness in the range of 10 D-45 D on a Shore Scale C, with a range of 25 D-35 D, and particularly preferably a hardness of 20 D being optimal for many patients. Suitable materials for the treatment structure 66, and possibly even the base structure 64, could be a polyurethane (PU) foam such as Poron® (Poron a foam product manufactured by Rogers Corporation (USA)) also known as PPT, Ethylene-vinyl acetate (EVA), Sponge rubber, felt, Plastazote® a closed cell cross-linked polyethylene foam manufactured by Zotefoams plc, or other foams will work within the described hardness range.

Depending on the material used, and the appropriate pressure for the particular patient, the differences in height 68 between the top surface 70 of the treatment area 58 and the top surface of 62 of the nontreatment area can be in a range of ⅛-¼ of an inch. Larger or smaller values are possible to treat plantar fasciitis and/or heel spur syndrome. Applicant has found that the recommended range is effective and comfortable for most patients.

The treatment area 58 can be short and small 1″×1″ covering just the navicular 13, 1st cuneiform 14 or just the cubiod 16. The treatment area 58 can be wide and long 2″×3″ cover and extending under the middle of the foot covering the navicular 13, 1st cuneiform 14 or just the cuboid 16, the 2nd cuneiform 15 and 3rd cuneiform 16 bones.

The treatment area 58 can be mostly any shape including square, rectangular, triangular, round, half round spherical, flat, square wedge, rectangular wedge, round with a domed top, X-shaped, star-shaped, arrow-shaped, e. g. “̂”, plus sign shaped e. g. “+”, or equal sign shaped “=”. In addition to these shapes the top surface of the treatment area 58 can incorporate a varying structure to stimulate and/or massage the foot. This varying surface structure can be a series of multiple X's, dots, nipples or domes to further massage the foot every step. These shapes can be from 1/16th to ¼ of an inch raised from the base top surface of the treatment area 58. The preferred raise would be ⅛ of an inch high. In the embodiment of FIG. 12, a rectangle wedge 204 is shown with a plurality of massage dimples 205. Alternatively the whole treatment area 58/treatment structure 66 can be a series of shapes, as described above, these shapes could be from ⅛ to ¾ of an inch high with a preferred height of ½″. The treatment area 58/treatment structure 66 can be used or incorporated into an existing orthotic, using a ⅛″ inch foam bloc, with or without domes, placed on top of the orthotic.

In the embodiment of FIG. 12, mounted on, or compressed from one single material, is a rectangular wedge 204 with a multiple series of small domes 205 having a preferred height of approximately ⅛ of an inch. The orthotic 60 of FIG. 12 is originally formed for the largest expected size of the foot, usually referred to as large and including US shoe sizes 12-15. This would have the orthotic 60 end at the edge 203. Trim lines such as 201 and 202 can be arranged on the orthotic 60 indicating how the orthotic 60 can be cut to be made for a smaller size foot. Trim line 201 is preferably arranged for a relatively small size, such as US shoe sizes 3-7, and trim line 202 for US shoe sizes 8-11.

The treatment area 58 in one embodiment is arranged on the orthotic 60 to apply the treatment pressure under a set of tendons which include the abductor hallucis of the foot, especially when the patient walks on the orthotic. The set of tendons can also include the flexor digitorum bevis of the foot, the plantar fascia of the foot, and the medial, lateral and central band of the plantar fascia of the foot. The treatment area 58 is arranged so that it is pressed against 10-100% of a total lateral width of the respective tendon(s), with 25-100% being more desirable 90-100% more desirable, but not significantly greater than 100% of the total lateral width of the respective tendon(s). The width direction being approximately/predominately in the direction 74 of FIG. 4. FIGS. 5 and 6 show the treatment area being of different widths across the foot. The actual width of the treatment area 58 depending on which tendons are to be activated, and how much of the width of the tendons is to be treated.

The length of the treatment area 58 is in a range of 10-75% of a total front to back length of the respective tendon(s). The treatment area 58 is arranged spaced from a proximal end of the respective tendon(s) by 20%-50% of a total length of the respective tendon(s). The treatment area 58 also preferably applies the treatment pressure to a midpoint of the respective tendon. The front to back length direction of the foot being approximately/predominately in the direction 76 of FIG. 4. The treatment area 58 is also preferably arranged spaced from an area of the foot from which the pain originates.

While specific embodiments of the invention have been shown and described in detail to illustrate the application of the principles of the invention, it will be understood that the invention may be embodied otherwise without departing from such principles.

### LIST OF REFERENCE CHARACTERS

8 lateral side
9 medial side
10 calcaneus
11 sustentaculum
12 talus
13 navicular
14 cuneiform
15 2nd cuneiform
16 cuboid
17 3rd cuneiform
18 styloid process
19 first metatarsal shaft
20 second metatarsal shaft
21 fifth metatarsal shaft
22 fourth metatarsal shaft
23 third metatarsal shaft
24 1st proximal phalanx
25 2nd proximal phalanx
26 3rd proximal phalanx
27 4th proximal phalanx
28 5th proximal phalanx
29 2nd middle phalanx
30 3rd middle phalanx
31 4th middle phalanx
32 5th middle phalanx
40 plantar fascia central band
41 plantar fascia medial band
42 plantar fascia lateral band
43 plantar fascia lateral band section
44 plantar fascia lateral band section
45 plantar fascia lateral band section
46 plantar fascia lateral band section
47 plantar fascia lateral band section
48
50 flexor digitorum brevis
51 flexor abductor hallucis
52 abductor digiti quinti
53 toe middle phalanx
54 toe middle phalanx
55 toe middle phalanx
56 toe middle phalanx
58 treatment area
59 non-treatment area
60 orthotic/orthosis
61 medial plantar fascia block/treatment area
62 lateral plantar fascia block/treatment area
64 base structure
66 treatment structure
68 treatment structure height
70 top surface treatment structure
72 top surface base structure
74 approximate width direction
76 approximate front-back direction

What is claimed is:

1. An orthotic for treating a patient with foot pain, the orthotic comprising:
a material with an orthotic surface pressing against a bottom of a foot of the patient, said material having a treatment area and a non-treatment area, said treatment area being arranged and formed to apply a treatment pressure under a set of tendons including an abductor hallucis of the foot, said treatment area applies said treatment pressure when the patient walks with said orthotic surface against the foot, said treatment area is arranged to apply said treatment pressure across 10-100% of a full lateral width of the abductor hallucis, said treatment area is arranged to apply said treatment pressure along front to back length of the foot in a range of 10% to 75% of a total length of the abductor hallucis, said non-treatment area being arranged around said treatment area, said treatment pressure being higher than a non-treatment pressure that said non-treatment area applies to the foot.

2. An orthotic in accordance with claim 1, wherein:
said treatment area is arranged spaced from a proximal end of the set of tendons by 20%-50% of a total length of the set of tendons.

3. An orthotic in accordance with claim 1, wherein:
said treatment pressure is 50-100 kPa higher than said non-treatment pressure.

4. An orthotic in accordance with claim 1, wherein:
said treatment pressure applies pressure in the range of 125-250 kPa to the foot when the patient stands on the orthotic.

5. An orthotic in accordance with claim 1, wherein:
said treatment pressure applies pressure in the range of 150-250 kPa to the foot when the patient stands on the orthotic.

6. An orthotic in accordance with claim 1, wherein:
said treatment area is formed of a material having a hardness in the range of 10 D-45 D on a Shore Scale C.

7. An orthotic in accordance with claim 1, wherein:
said treatment area is formed of a material having a hardness in the range of 25 D-35 D on a Shore Scale C.

8. An orthotic in accordance with claim 1, wherein:
said treatment area is arranged spaced from a pain area of the foot where the foot pain originates.

9. An orthotic in accordance with claim 1, wherein:
said treatment area includes a full lateral width of the abductor hallucis.

10. An orthotic in accordance with claim 1, wherein:
said treatment area includes a 25-100% of a full lateral width of the abductor hallucis.

11. An orthotic in accordance with claim 1, wherein:
said treatment area includes a 90-100% of a full lateral width of the abductor hallucis.

12. An orthotic in accordance with claim 1, wherein:
said set of tendons include an abductor brevis of the foot.

13. An orthotic in accordance with claim 1, wherein:
said set of tendons include a flexor digitorum bevis of the foot.

14. An orthotic in accordance with claim 1, wherein:
said set of tendons include a plantar fascia of the foot.

15. An orthotic in accordance with claim 1, wherein:
said set of tendons include a medial, lateral and central band of a plantar fascia of the foot.

16. An orthotic in accordance with claim 1, wherein:
said treatment area has a surface higher than a surface of said nontreatment area to cause said treatment pressure to be higher than said nontreatment pressure.

17. An orthotic in accordance with claim 16, wherein:
said surface of said treatment area is in a range of ⅛-¼ of an inch higher than said surface of said nontreatment area to cause said treatment pressure to be higher than said nontreatment pressure.

18. An orthotic in accordance with claim 1, wherein:
a material forming said treatment area is different from a material of said nontreatment area to cause said treatment pressure to be higher than said nontreatment pressure.

19. An orthotic in accordance with claim 1, wherein:
said treatment area is arranged to apply said treatment pressure to a midpoint of the set of tendons.

20. A method for treating a patient with foot pain, the method comprising the steps of:
a material with an orthotic surface pressing against a bottom of a foot of the patient, said material having a treatment area and a non-treatment area, said treatment area being arranged and formed to apply a treatment pressure under a set of tendons including an abductor hallucis of the foot, said treatment area applies said treatment pressure when the patient walks with said orthotic surface against the foot, said treatment area is arranged to apply said treatment pressure across 10-100% of a full lateral width of the abductor hallucis, said treatment area is arranged to apply said treatment pressure along front to back length of the foot in a range of 10% to 75% of a total length of the abductor hallucis, said non-treatment area being arranged around said treatment area, said treatment pressure being higher than a non-treatment pressure that said non-treatment area applies to the foot,
walking with said orthotic surface pressing against the bottom of the foot when the foot supports the patient.
